(19) United States
(12) Patent Application Publication
(10) Pub. No.: US 2023/0226613 A1
(43) Pub. Date: Jul. 20, 2023

(54) LAYER-BY-LAYER SOLVENT EVAPORATION

(71) Applicant: Hewlett-Packard Development Company, L.P., Spring, TX (US)

(72) Inventors: Krzysztof NAUKA, Palo Alto, CA (US); Michelle Miao NIU, Palo Alto, CA (US); Vladek P. KASPERCHIK, Corvallis, OR (US); Emre DISCEKICI, San Diego, CA (US)

(21) Appl. No.: 17/928,905

(22) PCT Filed: Jun. 8, 2020
(86) PCT No.: PCT/US2020/036665

§ 371 Date: Nov. 30, 2022

(51) Int. Cl. B22F 10/60; B22F 10/14; B29C 64/165; B29C 64/255; B22F 12/42; B33Y 10/00; B33Y 30/00; B33Y 40/20

(52) U.S. Cl. CPC B22F 10/60; B22F 10/14; B29C 64/165; B29C 64/255; B22F 12/42; B33Y 10/00; B33Y 30/00; B33Y 40/20

(57) ABSTRACT

In one example in accordance with the present disclosure, an additive manufacturing system is described. The additive manufacturing system includes a build material distributor to deposit metal powder build material and an agent distribution system to selectively deposit a binding agent on the metal powder build material in a pattern of a layer of a three-dimensional (3D) object to be printed. The additive manufacturing system also includes an ultraviolet (UV) energy source. The UV energy source, in a layer-by-layer fashion 1) cures the binding agent to join together metal powder build material with binding agent disposed thereon and 2) evaporates a solvent of the binding agent.

### BACKGROUND

Additive manufacturing systems produce three-dimensional (3D) objects by building up layers of material. Some additive manufacturing systems are referred to as “3D printing devices” and use inkjet or other printing technology to apply some of the manufacturing materials. 3D printing devices and other additive manufacturing devices make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system for layer-by-layer solvent evaporation, according to an example of the principles described herein.

FIG. 2 is a simplified top view of an additive manufacturing system for layer-by-layer solvent evaporation, according to an example of the principles described herein.

FIG. 3 is an isometric view of an additive manufacturing system for layer-by-layer solvent evaporation, according to an example of the principles described herein.

FIG. 4 is a flow chart of a method for layer-by-layer solvent evaporation, according to an example of the principles described herein.

FIG. 5 depicts the layer-by-layer solvent evaporation via ultraviolet (UV) energy, according to another example of the principles described herein.

FIG. 6 depicts solvent evaporation based on UV dosage, according to an example of the principles described herein.

FIG. 7 is a flow chart of a method for layer-by-layer solvent evaporation, according to an example of the principles described herein.

FIGS. 8A and 8B depict the layer-by-layer solvent evaporation via ultraviolet (UV) energy, according to another example of the principles described herein.

FIG. 9 depicts solvent evaporation using UV energy and a UV absorber, according to an example of the principles described herein.

FIG. 10 depicts a non-transitory machine-readable storage medium for layer-by-layer solvent evaporation, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) object through the solidification of layers of build material. Additive manufacturing systems make objects based on data in a 3D model of the object generated, for example, with a computer-aided drafting (CAD) computer program product. The model data is processed into slices, each slice defining portions of a layer of build material that are to be solidified.

In one particular example, a metal powder build material is deposited and a binding agent is selectively applied to the layer of metal powder build material. With a 3D object formed, the binding agent is cured to form a “green” 3D object. Cured binding agent holds the build material of the green object together. The green 3D object may then be exposed to electromagnetic radiation and/or heat to sinter the build material in the green 3D object to form the finished 3D object. It is to be understood that the term “green” does not connote color, but rather indicates that the part is not yet fully processed.

The binding agent may include binding component particles which are dispersed throughout a liquid vehicle. The binding component particles of the binding agent move into the vacant spaces between the metal powder build material particles. The binding component particles in the binding agent are activated or cured by heating the binding agent to about the melting point of the binding component particles. When activated or cured, the binding component particles glue the metal powder build material particles into the cured green object shape. The cured green object has enough mechanical strength such that it is able to withstand extraction from the build material platform without being deleteriously affected (e.g., the shape is not lost).

In other words, binding agent-assisted 3D printing of metals may involve a binding agent that includes a binding component with a solvent that controls the state of the binding. While the presence of the solvent is desired during a specific printing stage, after this stage the presence of the solvent may become detrimental. That is, the solvent may 1) prevent latex binding component particles from crusting in printhead nozzles and enabling reliable jetting and 2) when coalesced upon heating into a continuous polymer binder phase, glue metal particles in the patterned area of powder bed. However, after coalescence, the presence of the solvent may adversely impact the desired shape and mechanical properties of the green parts. Specifically, the presence of the solvent in cured latex may reduce the polymer binder modulus and, hence, printed part strength. Accordingly, the present specification describes the application of UV energy to evaporate the solvent in a binding agent.

In general, solvent is removed by either 1) in-situ, post-print extended annealing or 2) rapid heating with a xenon flash lamp with simultaneous removal of the solvent vapors by airflow lateral to irradiated surface of printed powder bed. However, either case may be inefficient. For example, in-situ annealing may take additional processing time and may limit a size of a 3D printed object. Using a xenon flash lamp may suffer from printer design complexity, overall cost, and difficulty of avoiding undesirable powder oxidation when flash heated. Accordingly, the present specification describes systems and methods for manufacturing a 3D object by a UV-assisted metal binder jet 3D additive manufacturing device.

According to a method, a layer of metal powder build material is deposited on a substrate. A binding agent, which may include a latex binding component, is deposited on the metal powder build material in a pattern to form a slice, or layer, of the 3D object. The method further involves curing the layer by selectively applying UV energy, wherein intensity and duration of UV light can be controlled. The UV energy is increased such that solvents in the binding agent evaporate leaving behind “hardened” binding component that has coated and bound the metal particles. Such a method may be performed in a layer-by-layer fashion. That is, for each layer of a 3D object to be formed, metal powder build material is deposited, a binding agent is deposited, and UV energy applied such that the binding component of the binding agent cures and a solvent of the binding agent evaporates out.

In one specific example, an additional agent is deposited to further enhance the solvent evaporation. Specifically, impinging UV radiation is absorbed by the metal powder regardless of whether binding agent is formed thereon. Accordingly, regions of metal powder that do not receive binding agent are also heated. It may be desirable for heat resulting from the UV exposure to be dissipated before the next powder layer is applied. Given the overall metal powder temperature, the duration of time for the metal powder to cool down may limit the number of layers that may be printed in a given amount of time. Accordingly, in this specific example, the metal powder build material that is to form the 3D object is selectively heated, thus reducing the temperature increase of adjacent, and non-object forming, metal powder. Doing so may increase the printing rate as the cool down period is reduced on account of the overall temperature of the bed not reaching as high a temperature.

This may be accomplished by applying two agents. A UV absorbing agent which matches the irradiation monochromatic wavelength of the UV energy source and the other being the binding agent. The UV absorbing agent provides an additional heating mechanism of the underlying metal powder build material such that less energy may be applied via the UV energy source to evaporate the solvents. As described above, applying less UV energy reduces the additional heat generated and transmitted throughout the layer such that more layers may be printed in a given amount of time.

Accordingly, the present specification describes the application of UV energy to evaporate a solvent of a binding agent, thus increasing object geometrical accuracy and mechanical robustness. In one particular example, a UV absorbing agent may be deposited to allow for increased heating in portions of the metal powder that are to form the 3D object. As the UV absorbing agent may allow for reduced UV intensity, the degree of heating non-object portions of the powder bed is reduced, which as described above may lead to higher printing rates.

Specifically, the present specification describes an additive manufacturing system. The additive manufacturing system includes a build material distributor to deposit metal powder build material and an agent distribution system to selectively deposit a binding agent on the metal powder build material in a pattern of a layer of a three-dimensional (3D) object to be printed. The additive manufacturing system also includes an ultraviolet (UV) energy source. The UV energy source, in a layer-by-layer fashion, 1) cures the binding agent to join together metal powder build material with binding agent disposed thereon and 2) evaporates a solvent of the binding agent.

The present specification also describes a method. According to the method, a metal powder build material is deposited and a binding agent is selectively applied on a portion of the metal powder build material that is to form a layer of a 3D object. The UV energy source is activated to cure the binding agent to join together metal powder build material particles with the binding agent disposed thereon and to evaporate a solvent of the binding agent.

The present specification also describes a non-transitory machine-readable storage medium encoded with instructions executable by a processor. The machine-readable storage medium includes instructions to, per layer of a multi-layer three-dimensional (3D) object to be printed, 1) control deposition of a metal powder build material on a surface, 2) control deposition of an ultraviolet (UV) absorbing agent in a pattern of a layer of the 3D object to be printed, 3) selectively activate a UV light-emitting diode (LED) array to evaporate a solvent of the UV absorbing agent, 4) control deposition of a binding agent in a pattern of a layer of the 3D object to be printed, 5) selectively activate the UV LED array to 1) cure the binding agent to join together metal powder build material particles with the binding agent disposed thereon and 6) evaporate a solvent of the binding agent.

Such systems and methods 1) remove binding agent solvent from a “green” 3D object; 2) increase dimensional accuracy and strength of “green” 3D objects; 3) provide selective heating of just those portions of the metal powder build material that are to form the 3D object; 4) exhibit high energy conversion and low thermal inertia; and 5) allow for patterning of heating radiation by selectively switching individual LEDs in a UV array. However, it is contemplated that the systems and methods disclosed herein may address other matters and deficiencies in a number of technical areas.

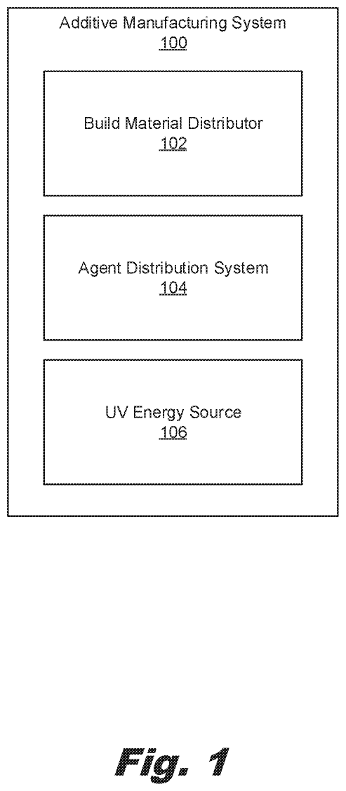

Turning now to the figures, FIG. 1 is a block diagram of an additive manufacturing system (100) for layer-by-layer solvent evaporation, according to an example of the principles described herein. The additive manufacturing system (100) of the current specification provides green 3D objects with increased mechanical strength and dimensional accuracy. The additive manufacturing system (100) provides such a green 3D object by using a UV energy source (106) to remove solvents from a binding agent used to form the green 3D object. In this example, the additive manufacturing system (100) may avoid using a UV absorbing agent. However, in some examples, the additive manufacturing system (100) may implement a UV absorbing agent to further increase the green object strength.

The additive manufacturing system (100) may include a build material distributor (102) to deposit metal powder build material on a surface. This metal powder build material may be the raw material from which a 3D object is formed. That is, portions of the metal powder build material that have a binding agent disposed thereon may, in the presence of heat, bind together to form a solid metal structure. The metal powder build material may be of a variety of types. For example, the metal powder build material may include metallic particles such as steel, bronze, titanium, aluminum, nickel, cobalt, iron, nickel cobalt, gold, silver, platinum, copper and alloys of the aforementioned metals. While several example metals are mentioned, other alloy build materials may be used in accordance with the principles discussed herein.

The build material distributor (102) may acquire build material from a build material supply receptacle and deposit the acquired material as a layer in a bed, which layer may be deposited on top of other layers of build material already processed that reside in the bed.

The additive manufacturing system (100) also includes an agent distribution system (104). As described above, different agents may be distributed. In one example, the agent distribution system (102) selectively deposits a binding agent on the metal powder build material in a pattern of a layer of a 3D object to be printed. Specifically, within a build area, portions of the metal powder are to be fused together. The fused portions form a layer, or slice, of a 3D object. The binding agent includes various components that when interoperating together join the metal powder particles on which it is dispersed, into a semi-rigid structure. Specifically, the binding agent may include an aqueous carrier, a solvent, and a binding component. The aqueous carrier allows the binding agent to wet the metal powder build material such that the solvent and the binding component can penetrate into the pores of a layer. The solvent 2) prevents the binding component particles from crusting in the agent distribution system (104) nozzles and 3) causes coalescing of the binding components upon heating. The binding components, when cured, join the metal powder build material together such that it forms a cohesive object that while not strong, may be transported to a sintering furnace where high pressure and high temperature are used to melt or sinter the glued metal powder build material together into a single cohesive 3D object.

The liquid carrier may refer to the liquid fluid in which the binding component particles are dispersed to form the binding agent. A wide variety of liquid carriers, including aqueous and non-aqueous vehicles, may be used with the binding agent. In some instances, the liquid carrier is a solvent with no other components. In other examples, the binding agent may include other ingredients, depending in part upon the agent distribution system (104).

In some examples, the binding agent includes the binding component and the solvent with no liquid carrier. In these examples, the solvent makes up the balance of the binding agent. Accordingly, the liquid carrier may be water containing non-aqueous solvent. Specific examples of non-aqueous solvents include aliphatic alcohols, aromatic alcohols, diols, glycol ethers, polyglycol ethers, 2-pyrrolidinones, caprolactams, formamides, acetamides, and long chain alcohols, primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, both substituted and unsubstituted formamides, both substituted and unsubstituted acetamides, propyleneglycol ethers such as dipropyleneglycol monomethyl ether, dipropyleneglycol monopropyl ether, dipropyleneglycol monobutyl ether, tripropyleneglycol monomethyl ether, tripropyleneglycol monobutyl ether, dipropyleneglycol monophenyl ether, 2-pyrrolidinone and 2-methyl-1,3-propanediol and the like).

The binding component may be a latex polymer (i.e., polymer that is capable of being dispersed in an aqueous medium) that is jettable via inkjet printing (e.g., thermal inkjet printing or piezoelectric inkjet printing). In some examples disclosed herein, the polymer particles are heteropolymers or co-polymers. The heteropolymers may include a more hydrophobic component and a more hydrophilic component. In these examples, the hydrophilic component renders the particles dispersible in the aqueous carrier while the hydrophobic component is capable of coalescing upon exposure to heat in order to temporarily bind the metal powder build material particles together to form the green object. Examples of binding components include (A) a co-polymerizable surfactant and (B) styrene, p-methyl styrene, α-methyl styrene, methacrylic acid, methyl methacrylate, hexyl acrylate, hexyl methacrylate, butyl acrylate, butyl methacrylate, ethyl acrylate, ethyl methacrylate, 2-ethylhexyl acrylate, 2-ethylhexyl methacrylate, propyl acrylate, propyl methacrylate, octadecyl acrylate, octadecyl methacrylate, stearyl methacrylate, vinylbenzyl chloride, isobornyl acrylate, tetrahydrofurfuryl acrylate, 2-phenoxyethyl methacrylate, benzyl methacrylate, benzyl acrylate, ethoxylated nonyl phenol methacrylate, ethoxylated behenyl methacrylate, polypropyleneglycol monoacrylate, isobornyl methacrylate, cyclohexyl methacrylate, cyclohexyl acrylate, t-butyl methacrylate, n-octyl methacrylate, lauryl methacrylate, tridecyl methacrylate, alkoxylated tetrahydrofurfuryl acrylate, isodecyl acrylate, isobornyl methacrylate, isobornyl acrylate, dimethyl maleate, dioctyl maleate, acetoacetoxyethyl methacrylate, diacetone acrylamide, N-vinyl imidazole, N-vinylcarbazole, N-vinyl-caprolactam, or combinations thereof. In some examples, the latex binding component particles are acrylic. In some examples, the latex polymer particles include 2-phenoxyethyl methacrylate, cyclohexyl methacrylate, cyclohexyl acrylate, methacrylic acid, styrene, methyl methacrylate, butyl acrylate, and methacrylic acid.

In some examples, the co-polymerizable surfactant includes a polyoxyethylene compound, polyoxyethylene alkylphenyl ether ammonium sulfate, sodium polyoxyethylene alkylether sulfuric ester, polyoxyethylene styrenated phenyl ether ammonium sulfate, or mixtures thereof. While specific reference is made to certain binding component, other binding component may be implemented in accordance with the principles described herein.

As described above, the solvent plasticizes the binding component particles and enhances the coalescing of the binding component upon exposure to heat in order to temporarily bind the metal powder build material particles together to form the green part.

In some examples, the solvent may be a lactone, such as 2-pyrrolidinone, 1-(2-hydroxyethyl)-2-pyrrolidone, etc. In other examples, the solvent may be a glycol ether or a glycol ether esters, such as tripropylene glycol mono methyl ether, dipropylene glycol mono methyl ether, dipropylene glycol mono propyl ether, tripropylene glycol mono n-butyl ether, propylene glycol phenyl ether, dipropylene glycol methyl ether acetate, diethylene glycol mono butyl ether, diethylene glycol mono hexyl ether, ethylene glycol phenyl ether, diethylene glycol mono n-butyl ether acetate, ethylene glycol mono n-butyl ether acetate, etc. In still other examples, the coalescing solvent may be a water-soluble polyhydric alcohol, such as 2-methyl-1,3-propanediol, etc. In still other examples, the coalescing solvent may be a combination of any of the examples above. In still other examples, the coalescing solvent is selected from the group consisting of 2-pyrrolidinone, 1-(2-hydroxyethyl)-2-pyrrolidone, tripropylene glycol mono methyl ether, dipropylene glycol mono methyl ether, dipropylene glycol mono propyl ether, tripropylene glycol mono n-butyl ether, propylene glycol phenyl ether, dipropylene glycol methyl ether acetate, diethylene glycol mono butyl ether, diethylene glycol mono hexyl ether, ethylene glycol phenyl ether, diethylene glycol mono n-butyl ether acetate, ethylene glycol mono n-butyl ether acetate, 2-methyl-1,3-propanediol, and a combination thereof.

In some examples, the agent distribution system (104) deposits an additional agent. That is, it may be the case that a certain percentage of UV energy impinging on the metal powder build material is absorbed. To increase this percentage, the agent distribution system (104) may selectively deposit a UV absorbing agent on the metal powder build material. The UV absorbing agent may be deposited in the same pattern as the binding agent to increase the absorption properties of just those portions of the metal powder build material that are to form the 3D object.

Accordingly, as UV energy is irradiated, the entire powder bed area absorbs and gets heated. However additional absorption (and heating) takes place where the UV absorbing agent was deposited. As both the binding agent and the UV absorbing agent are printed in the same areas, UV absorbing agent provides additional, and selective heating of the metal powder that is to form the green 3D object. Thus, UV absorbing agent-coated regions get hotter than surrounding regions free of the UV absorbing agent. In other words, the portions of the metal powder build material that have the binding agent and the UV absorbing agent disposed thereon get hot enough faster while surrounding agent-free areas are at a lower temperature.

Doing so may conserve energy as less is used to raise the layer-forming portions of the powder metal build material to curing temperatures. Moreover, keeping areas free of UV absorbing agent at a lower temperature reduces powder oxidation. Oxidation may result in raw build material being un-recyclable. Accordingly, by using a UV absorbing agent, unused metal powder build material may be recycled for subsequent use. Moreover, as the overall temperature of the metal powder build area is not as high, printing is quicker as the build material cools faster.

In some examples, the UV absorbing agent may be an organic compound or an inorganic compound. As a specific example, the UV absorbing agent may include diaryl and triarylmethane dyes, UV-absorbing porphyrins such as porphyrin cobalt, nitro dyes, azo-dyes such as dimethylaminobenzene and azobenzene, carbonyl dyes, and UV brighteners.

In examples where the agent distribution system (104) deposits a UV absorbing agent in addition to the binding agent, the agent distribution system (104) may separately distribute the binding agent and the UV absorbing agent. For example, the agent distribution system (104) may deposit a UV absorbing agent in a first pass and in a second pass may distribute the binding agent. In another example, the agent distribution system (104) may deposit the binding agent in a first pass and in the second pass may distribute the UV absorbing agent. In another example, the binding agent and the UV absorbing agent may be mixed and deposited as a single compound. In the case of separate deposition of the binding and the UV absorbing agent, the amount of UV absorbing agent may be tuned to accelerate or decelerate solvent removal. In the case of a mixture, the ratio of the two may be predetermined.

In some examples, an agent distribution system (104) includes at least one liquid ejection device to distribute the agents onto the layers of build material. A liquid ejection device may include at least one printhead (e.g., a thermal ejection based printhead, a piezoelectric ejection based printhead, etc.). In some examples, the agent distribution system (104) is coupled to a scanning carriage, and the scanning carriage moves along a scanning axis over a bed. In one example, printheads that are used in inkjet printing devices may be used in the agent distribution system (104). In this example, the fusing agent may be a printing liquid. In other examples, an agent distribution system (104) may include other types of liquid ejection devices that selectively eject small volumes of liquid.

The additive manufacturing system (100) may include an ultraviolet (UV) energy source (106) to, in a layer-by-layer fashion, cure the binding agent to join together metal powder build material with a binding agent disposed thereon. That is, as described above, when heated, the binding agent cures to join metal powder particles together into a green 3D object. A green 3D object refers to an intermediate part that has a shape representative of the final 3D object and that includes metal powder build material patterned with the binding agent. In the green 3D object, the metal powder build material particles may be weakly bound together by components of the binding agent and/or by attractive force(s) between the metal powder build material particles and the binding agent. Any metal powder build material that is not patterned with the binding agent is not considered to be part of the green 3D object, even if it is adjacent to or surrounds the green 3D object.

Upon further exposure to the UV energy source (106), the green 3D object begins to cure which initiates dissolving of the binding component in the solvent in the binding agent formulation so that the binding component forms a polymer glue that coats the metal powder build material particles and creates or strengthens the bond between the metal powder build material particles. In other words, the cured green 3D object is an intermediate part with a shape representative of the final 3D printed object and that includes metal powder build material bound together by at least partially cured binding component of the binding agent. Compared to the uncured green 3D object, the mechanical strength of the cured green 3D object is greater, and in some instances, the cured green 3D object can be handled or extracted from the build material platform.

To cure the binding agent and join together metal powder build material, the UV energy source (106) may heat the build material to a temperature wherein the binding component is cured. During this operation, the UV energy source (106) may have an irradiation power that is emitted as well as a duration of exposure for binding component curing. To cure the binding component, the UV energy source (106) may be driven such that the metal powder build material is heated to a temperature of between 50 degrees Celsius and 150 degrees Celsius. In some examples, this may include driving the UV energy source (106) with a lower irradiation power value for a longer period of time. In another example, this may include driving the UV energy source (106) with a higher irradiation power value for a shorter period of time.

The UV energy source (106) may then be driven for a longer period of time to evaporate the solvent of the binding agent. That is, at some point, the metal powder build material temperature reaches a point when curing starts/binder particles become dissolved in solvent and the dissolved binder flows, coats, and binds adjacent metal powder particles. At this point, the UV energy source (106) continues to be driven such that the bed temperature reaches a point where the binding agent solvent evaporates. In some examples, this may include driving the UV energy source (106) to heat the bed beyond the 50-150 degrees Celsius to cure the binding agent. Specifically, the UV energy source (106) may be driven to heat the bed to between 150-250 degrees Celsius so that the solvent evaporates.

In other words, the present specification activates the UV energy source (106) not only to a point where the binding component cures, but to a further point where the solvent evaporates. As described above, the solvent, while desirable in certain stage of printing such as pre-printing and coalescing, may have a deleterious effect on the 3D object if left in the 3D object during the sintering phase. Accordingly, the present additive manufacturing system (100) by operating the UV energy source (106) in such a way as to evaporate the solvent increases mechanical strength and enhances the properties of a resulting 3D object.

Driving the UV energy source (106) to evaporate the solvent may include heating the metal powder build material to a temperature greater than 150 degrees Celsius. In some examples, as will be described below, the UV energy source (106) emits energy having a wavelength of between 240 and 450 nanometers.

As will be described below, in some examples, the additive manufacturing system (100) may operate in a layer-by-layer fashion. That is, the build material distributor (102) may deposit a layer of metal powder build material and the agent distribution system (104) may deposit a layer of binding agent. The UV energy source (106) may then cure the binding agent and evaporate the solvent. This process may then repeat for each layer that is to form the 3D object.

In some examples, the UV energy source (106) is an array of UV light-emitting diodes (LEDs). The UV LEDs may be individually controllable such that selective operation of each LED, or group of LEDs, may allow for localized curing and evaporation. For example, rather than heating the entire layer, a subset of the UV LEDs could be activated, which subset correspond to an area of the build area that receives binding agent and/or UV absorbing agent or an area of the bed extending further than just those areas that are to receive the binding agent and/or UV absorbing agent to ensure complete UV treatment.

Specific examples of each operation, i.e., with and without UV absorbing agent are now presented. First as an example where no UV absorbing agent is used. Such an operation provides a simplified process of solvent removal in the additive manufacturing process in a layer-by-layer fashion where momentary temperature increases are used to evaporate the solvent. In one test, a 300-um thick layer of MIM-grade stainless steel powder (316L) was spread on a glass substrate and rectangular patterns of binding agent were printed on the substrate, all while keeping the powder bed at 35 degrees Celsius. After printing was completed, the specimen was placed under an array of UV LEDs emitting at 395 nanometers (nm) capable of uniformly irradiating the metal powder build material with constant energy of about 12 W/cm2. The LED wavelength was selected to fall into a wide spectral, where powder absorption is constant at around 74%. The duration of illumination was varied from one to a few seconds. The removal of the solvent was tested with a thermogravimetric analysis (TGA) device capable of sensing weight decrease when powder's temperature is raised at a constant rate and respective volatile components are evaporated at their respective temperatures. For a given volatile component, a weight drop corresponding to its evaporation indicates that it was at least partially removed from the metal powder layer. The magnitude of the weight drop was used to quantify the amount of removed volatile component (ex. binder's solvent).

As such, the additive manufacturing system (100) of the present disclosure provides an effective mechanism for removing solvents from newly printed binding agent while simultaneously providing the temperature desired for binding agent coalescence.

Turning now to an example implementing both a binding agent and a UV absorbing agent. In a test, a latex binding component was used and a yellow ink as a UV absorbing agent. In this example, the yellow ink matched the UV emission, however other UV absorbing agents may be implemented in accordance with the principles described herein.

In the test, a 300-um thick layer of metal powder was spread on a glass substrate and both the UV absorbing agent and latex binding agent were printed in a rectangular pattern. In this example, the powder bed was kept at around 35 degrees Celsius. The patterned regions were placed under the UV LED source and uniformly irradiated with a controlled irradiation power density and time. Specifically, 12 W/cm2 UV irradiation lasting 1 second was applied for the test. UV absorption caused momentary heating of the metal powder while irradiation lasted and led to volatilization and evaporation of the solvents. Due to small thermal mass powder's temperature dropped immediately to room temperature after UV irradiation was terminated.

Results compared the amount of solvent left in the latex printed region of the powder layer when, in addition to latex binding agent, a UV absorbing agent was or was not present. In addition, reference samples containing a single agent (either latex binding agent or yellow UV absorbing agent) were tested. Table (1) below indicates the results.

TABLE 1

| | | Solvent |
|---|---|---|
| | | Content after |
| Experiment | | print sequence |
| # | Print Sequence | (mg) |
| 1 | Latex binding agent (no UV) | 0.1969 |
| 2 | Latex binding agent and UV | 0.0679 |
| 3 | Yellow UV absorbing agent (no UV) | 0.4138 |
| 4 | Yellow UV absorbing agent and UV | 0.0035 |
| 5 | Yellow UV absorbing agent and UV | 0.0040 |
| | followed by latex binding agent and | |
| | UV | |
| 6 | Yellow UV absorbing agent and UV | 0.2019 |
| | followed by latex binding agent | |

In Table 1, the sample sizes were standardized to enable a direct comparison. In this test, the solvent was removed from the first printed ink (by UV exposure) before the second ink is printed and UV exposed in order to reliably measure the effect of UV heating of the second printed ink.

After printing, samples were removed and tested with the TGA device. From the above test, printed latex binding agent and yellow UV absorbing agent both contain large amounts of solvent (see experiments 1 and 3). This test also indicates that UV irradiation of the latex binding agent may remove about 65% of solvent content (see experiments 1 and 2). UV irradiation of the yellow UV absorbing agent may remove close to 100% of solvent content leaving “dry” yellow UV absorbing agent (see experiments 3 and 4). Application of a UV absorbing agent and removal of its solvent by UV treatment followed by application of a latex binding agent and UV treatment to remove the binding agent solvent removes about 98% of solvent from the latex binding agent (see experiments 1 and 5). Thus, application of a UV absorbing agent may provide 17 times increase in solvent removal as compared to the case when latex binding agent is irradiated but the UV absorbing agent is not used. A comparison of experiments 1 and 6 (yellow UV absorbing agent and UV-based solvent evaporation followed by latex binding agent without UV irradiation) shows the same amount of solvent as present in the original latex binding agent.

Accordingly, as described above, heat-selectivity (ability to heat latex coated regions more effectively than powder bed areas that are free of the latex binding agent) provides enhanced additive manufacturing. That is, the proposed heat-selectivity may provide an energy savings. Additionally, use of a UV absorbing agent may prevent uncontrolled heat buildup in the additive manufacturing system (100) caused by unwanted and excessive UV absorption in the binding agent-free regions of the powder bed. As described above, gradual heat buildup in these binding agent-free regions may disrupt the printing process and may limit the maximum number of printed layers.

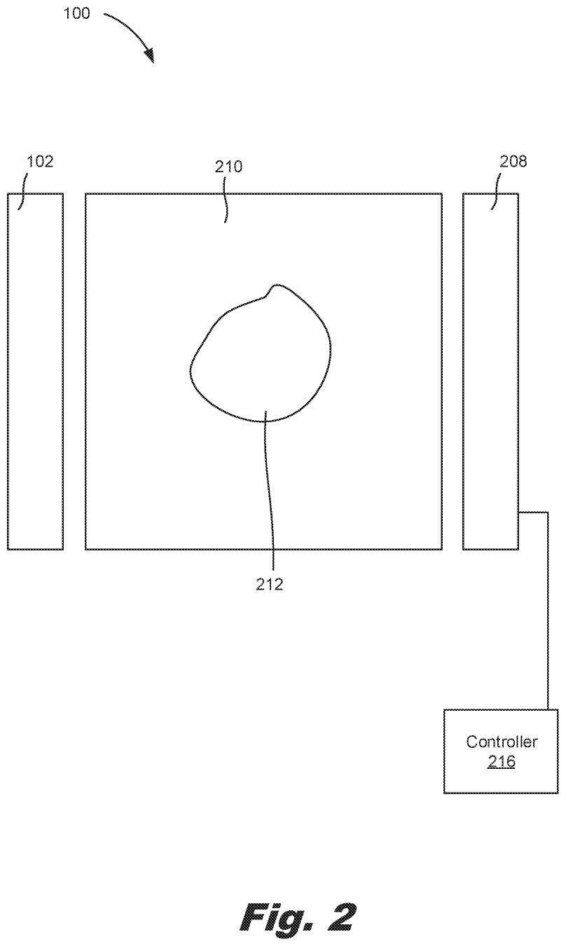

FIG. 2 is a simplified top view of an additive manufacturing system (100) for layer-by-layer solvent evaporation, according to an example of the principles described herein. In an example of an additive manufacturing process, a layer of build material may be formed in a build area. As used in the present specification and in the appended claims, the term “build area” refers to an area of space wherein the 3D object (212) is formed. The build area may refer to a space bounded by a bed (210). The build area may be defined as a three-dimensional space in which the additive manufacturing system (100) can fabricate, produce, or otherwise generate a 3D object (212). That is, the build area may occupy a three-dimensional space on top of the bed (210) surface. In one example, the width and length of the build area can be the width and the length of bed (210) and the height of the build area can be the extent to which bed (210) can be moved in the z direction. Although not shown, an actuator, such as a piston, can control the vertical position of bed (210).

The bed (210) may accommodate any number of layers of metal powder build material. For example, the bed (210) may accommodate up to 4,000 layers or more. In an example, a number of build material supply receptacles may be positioned alongside the bed (210). Such build material supply receptacles source the build material that is placed on the bed (210) in a layer-by-layer fashion.

In some examples, the metal powder build material may be kept warm, for example between 60 and 100 degrees Celsius. Doing so may aid in the removal of some of the volatile compounds that may be found in the agents. In some examples, such heating may be achieved with resistive heaters built into the bed (210) or with overhead infrared (IR) and/or UV heaters.

In the additive manufacturing process, a binding agent may be deposited on the layer of build material that facilitates the gluing of the powder build material particles together. In this specific example, the binding agent may be selectively distributed on the layer of build material in a pattern of a layer of a 3D object (212). A UV energy source (FIG. 1, 106) may temporarily apply energy to the layer of build material. The energy can be absorbed selectively into patterned areas formed by the binding agent, which leads to a curing of the binding component which glues the metal powder build particles together. This process is then repeated, for multiple layers, until a complete physical object has been formed.

FIG. 2 clearly depicts the build material distributor (102). As described above, the build material distributor (102) may acquire build material from a build material supply receptacle and may deposit the material as a layer in the bed (210), which layer may be deposited on top of other layers of build material already processed that reside in the bed (210).

In some examples, the build material distributor (102) may be coupled to a scanning carriage. In operation, the build material distributor (102) places build material in the bed (210) as the scanning carriage moves over the bed (210) along the scanning axis.

FIG. 2 also depicts a carriage (208) on which the UV energy source (FIG. 1, 106) and the agent distribution system (FIG. 1, 104) are disposed. That is, in some examples, the UV energy source (FIG. 1, 106) is mobile over the bed (210).

In other examples, the carriage (208) may include just the agent distribution system (FIG. 1, 104). In this example, the UV energy source (FIG. 1, 106) may be immobile. For example, the UV energy source (FIG. 1, 106) may be mounted above the bed (210). In yet another example, the additive manufacturing system (100) may include multiple UV energy sources (FIG. 1, 106), one of which may be mobile on the carriage (208) and another which is immobile and fixed above the bed (210).

FIG. 2 also depicts a controller (216) which may individually control each of the UV LEDs that make up the UV energy source (FIG. 1, 106). That is, as described above, the UV energy source (FIG. 1, 106) may include multiple UV LEDs, each of which may be controlled individually. Accordingly, a single UV LED may be activated, or a group of UV LEDs may be activated. As such, the controller (216) provides enhanced customization and control over UV irradiation. For example, rather than activating each UV LED in the array, the controller (216) may activate the subset of UV LEDs that are to pass over portions of the bed (210) that receive the binding agent and/or the UV absorbing agent. Thus, rather than activating all UV LEDs and heating the entire powder bed (210), just those portions of the bed (210) that correspond to the 3D green object, are heated. Accordingly, the additive manufacturing system (100) provides a cost-savings as less energy is used.

In another example, individually controlling the UV LEDs may allow for different of the UV LEDs to be activated to different intensities. For example, in areas where wider variety in geometric accuracy and mechanical strength are tolerated, for example on an interior portion of the 3D object, a lower intensity may be used such that the corresponding metal powder build material is not heated to as high of a temperature. By comparison, where less variety in geometric accuracy and mechanical strength are tolerated, a greater UV intensity may be used to ensure proper solvent removal to ensure target geometric dimensions and mechanical strength.

The controller (216) may include various hardware components, which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (216) cause the controller (216) to implement at least the functionality of interrupting printing and resuming printing as described below.

The controller (216) also controls the additive manufacturing. Specifically, in a binding agent-based system, the controller (216) may direct a build material distributor to add a layer of build material. Further, the controller (216) may send instructions to direct a printhead of an agent distributor to selectively deposit the agent(s) onto the surface of a layer of the build material. The controller (216) may also direct the printhead to eject the agent(s) at specific locations to form a 3D printed object slice.

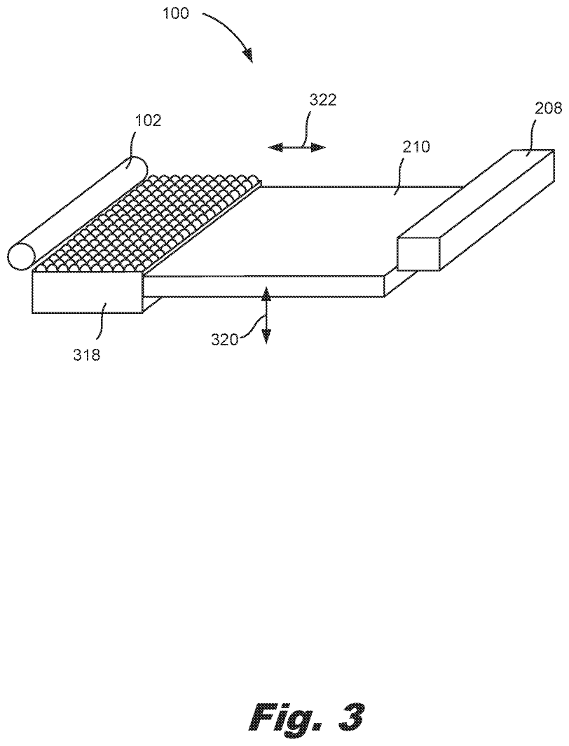

FIG. 3 is an isometric view of an additive manufacturing system (100) for layer-by-layer solvent evaporation, according to an example of the principles described herein. Components of the additive manufacturing system (100) depicted in FIG. 3 may not be drawn to scale and thus, the additive manufacturing system (100) may have a different size and/or configuration other than as shown therein.

FIG. 3 clearly depicts the bed (210) which receives the metal powder build material from the build material supply receptacle (318). In some examples, the bed (210) may be moved in a direction as denoted by the arrow (320), e.g., along the z-axis, so that metal powder build material may be delivered to the bed (210) or to a previously formed layer of metal powder build material. For each subsequent layer of metal powder build material to be delivered, the bed (210) may be lowered so that the build material distributor (102) can push the metal powder build material particles onto the bed (210) to form a layer of the metal powder build material thereon.

The build material supply receptacle (318) may be a container, bed, or other surface that is to position the metal powder build material particles between the build material distributor (102) and the bed (210). In some examples, the build material supply receptacle (318) may include a surface upon which the metal powder build material particles may be supplied, for instance, from a build material source (not shown).

As described above, the build material distributor (102) may move in a direction as denoted by the arrow (322), e.g., along the y-axis, over the build material supply receptacle (318) and across the bed (210) to spread a layer of the metal powder build material. The build material distributor (102) may also be returned to a position adjacent to the build material supply receptacle (318) following the spreading of the metal powder build material. In some examples, the build material distributor (102) may be a blade (e.g., a doctor blade), a roller, a combination of a roller and a blade, and/or any other device capable of spreading the metal powder build material particles over the platform (210).

FIG. 3 also depicts the carriage (208) that may be scanned across the bed (210) in the direction indicated by the arrow (322) and that may include the agent distribution system (FIG. 1, 104) and in some examples the UV energy source (FIG. 1, 106). The carriage (208) and the printheads formed thereon may extend a width of the bed (210).

Each of the previously described physical elements may be operatively connected to the controller (FIG. 2, 216). That is, the controller (FIG. 2, 216) may control the operations of the bed (210), the build material supply receptacle (318), the build material distributor (102), the carriage (208), UV energy source (FIG. 1, 106), and the agent distribution system (FIG. 1, 104).

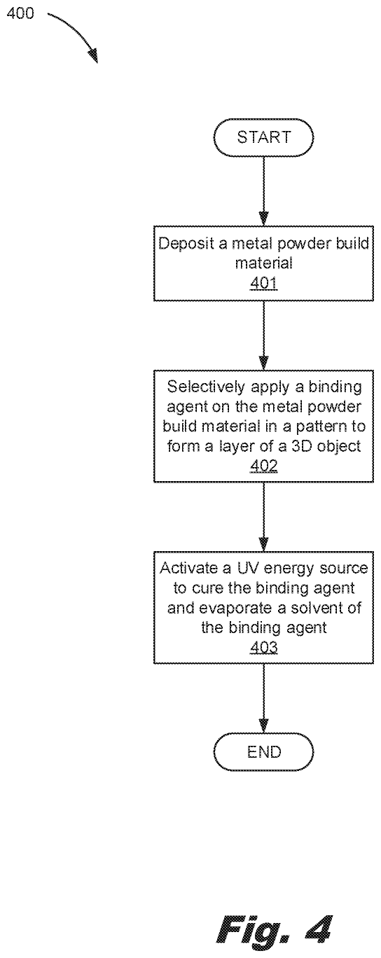

FIG. 4 is a flow chart of a method (400) for layer-by-layer solvent evaporation, according to an example of the principles described herein. That is, each of the operations detailed in FIG. 4 may be performed for an individual layer that is to form a green 3D object (FIG. 2, 212). According to the method (400), a metal powder build material is deposited (block 401) on a surface. The surface may be a bed (FIG. 2, 210) or a previously deposited layer of metal powder build material. For example, under the direction of a controller (FIG. 2, 216), a build material distributor (FIG. 1, 102) may spread the supplied metal powder build material particles onto the bed (FIG. 2, 210).

With metal powder build material spread, the method (400) includes selectively applying (block 402) a binding agent on a portion of the metal powder build material that is to form a layer of a 3D object (FIG. 2, 212). As described above, the binding agent is applied (block 402) via an agent distribution system (FIG. 1, 104). Specifically, the controller (FIG. 2, 216) may execute instructions to control the agent distribution system (FIG. 1, 104) to deposit the binding agent onto predetermined portion(s) of the metal powder build material that are to become part of a green object and are to ultimately be sintered to form the 3D object (FIG. 2, 212). As an example, if the 3D object (FIG. 2, 212) that is to be formed is to be shaped like a cube or cylinder, the binding agent may be deposited in a square pattern or a circular pattern (from a top view), respectively, on at least a portion of the layer of the metal powder build material particles.

When the binding agent is selectively applied (block 402) in the desired portion(s), the binding component particles (present in the binding agent) infiltrate the inter-particle spaces among the metal powder build material particles. By comparison, portions of the metal powder build material that do not have the binding agent applied thereto, do not have the binding component particles introduced thereto. As such, these portions do not become part of the 3D object (FIG. 2, 212) that is ultimately formed.

According to the method (400), the UV energy source (FIG. 1, 106) is activated (block 403) to cure the binding agent and to evaporate a solvent of the binding agent. In some example, this may include emitting UV waves having a wavelength of between 240-450 nanometers, and as a specific example of 395 nm, for a period of 0.5 to 5 seconds. As heat is applied, the solvent in the binding agent activates the latex binding component such that it begins to glue the particles of the metal powder build material together. As described above, the UV energy source (FIG. 1, 106) may include UV LEDs such that a subset, or even one, UV LED may be activated at a time. Accordingly, selective portions of the metal powder build material, specifically those portions that are to form the 3D object, may be targeted.

Heating to form the cured green part layer may take place at a temperature that is capable of activating (or curing) the binding agent, but that does not melt or sinter the metal powder build material. In an example, the activation temperature is about the melting point of the binding component. As a specific example, the metal powder build material may be heated to a temperature of between 50 and 150 C.

Such activation of the UV energy source (FIG. 1, 106) also evaporates the solvent of the binding agent. In some examples, activating to this more intense state may include exposing the metal powder build material to the UV energy source (FIG. 1, 106) for a longer period of time than used to cure the binding component. Doing so causes the underlying metal powder build material to heat up even more. In the case of portions of metal power build material that have a binding agent disposed thereon, the increased intensity of UV irradiation causes these portions to heat to a sufficient temperature, such as greater than 150 C, wherein the solvent in the binding agent evaporates. Increasing the exposure to evaporate the solvent may include slowing down the carriage (FIG. 2, 208) on which the UV energy source (FIG. 1, 106) is disposed or otherwise increasing the period of time for which the UV energy source (FIG. 1, 106) is active.

As described above, these operations (blocks 401, 402, 403) may be repeated to iteratively build up multiple patterned layers and to form the green 3D object (FIG. 2, 212). For example, the controller (FIG. 2, 216) may execute instructions to cause the bed (FIG. 2, 210) to be lowered to enable the next layer of metal powder build material to be spread. In addition, following the lowering of the bed (FIG. 2, 210), the controller (FIG. 2, 216) may control the build material supply receptacle (FIG. 3, 318) to supply additional metal powder build material (e.g., through operation of an elevator, an auger, or the like) and the build material distributor (FIG. 1, 102) to form another layer of metal powder build material particles on top of the previously formed layer. The newly formed layer may be patterned with binding agent and the UV energy source (FIG. 1, 106) may be activated to cure the binding agent and evaporate the solvent.

Evaporating solvent from just a portion of the 3D object as opposed to the entire 3D object may take less time and energy to accomplish.

Subsequent to curing, the green object (FIG. 2, 212) may be extracted from the build material cake and placed in a heating mechanism such as a sintering furnace where it is heated to a sintering temperature. Sintering is accomplished at a temperature that is sufficient to sinter the remaining metal powder build material particles. Temperature ranges may be between 450-1700 degrees Celsius depending on the material, to sinter the metal particles to form a solid cohesive structure. That is, while these temperatures are provided as sintering temperature examples, it is to be understood that the sintering heating temperature depends upon the metal powder build material that is utilized, and may be higher or lower than the provided examples. The sintering temperature is dependent upon the composition of the metal powder build material particles. As part of this heating, the binding agent is decomposed such that the binding component particles are no longer present in the final 3D object.

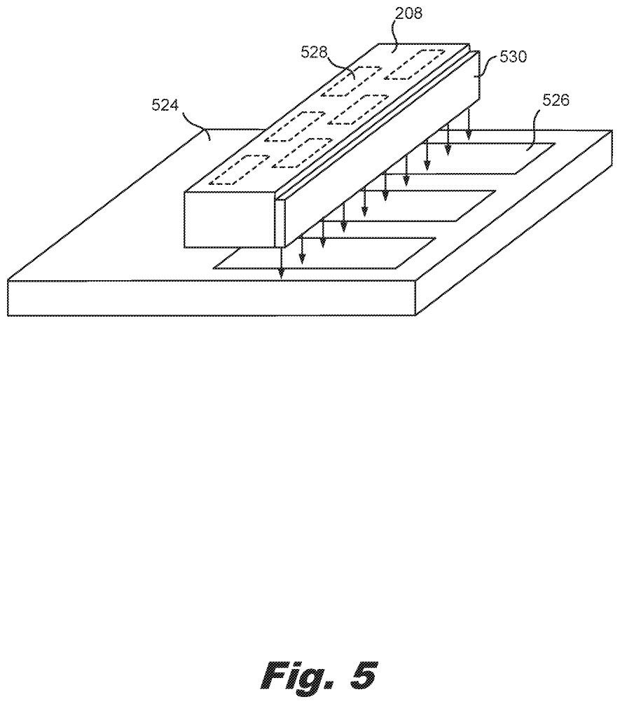

FIG. 5 depicts the layer-by-layer solvent evaporation via ultraviolet (UV) energy, according to another example of the principles described herein. Specifically, FIG. 5 depicts an example where a UV absorbing agent is not deposited. As depicted in FIG. 5, a carriage (208) may pass over the surface of the metal powder build material (524). While the carriage (208) is moving, printheads (528) of the agent distribution system (FIG. 1, 104) may be activated to eject a binding agent (526) on the metal powder build material (524). For simplicity, a single printhead (528) of the agent distribution system (FIG. 1, 104) is indicated with a reference number. In the example depicted in FIG. 5, the layer, i.e., the cross-section of the 3D object (FIG. 2, 212), is a series of rectangles. For example, the 3D object(s) (FIG. 2, 212) may be rectangular prisms.

FIG. 5 also depicts the UV energy source (FIG. 1, 106) which in the example depicted in FIG. 5 is an array (530) that is mounted to the carriage (208). As described above, in other examples the UV energy source (FIG. 1, 106) may be immobile and fixed above the bed (FIG. 2, 210). In either example, the UV energy source (FIG. 1, 106) is active simultaneously with, or shortly after the deposition of the binding agent (526). In one particular example, the printheads (528) may eject the binding agent (526) while the carriage (208) passes in a first direction and the UV array (530) may be activated while the carriage (208) passes in the opposite direction, in a return path. Doing so allows sufficient time for the binding agent (526) to infiltrate into the pores of the metal powder build material (524). In this example, the speed of the carriage (208) may be adjusted to ensure UV irradiation to evaporate the solvent.

In another example, the UV energy source (FIG. 1, 106) and the printheads (528) may be active during the same pass. That is, on the same pass that the printheads (528) deposit the binding agent (526), the UV array (530) may be activated to cure the binding agent (526) and to evaporate the solvent therein. In these examples, the speed of the carriage (208) may be adjusted to ensure infiltration of the binding agent (526) before the UV array (530) irradiates the surface and to ensure UV irradiation to adequately evaporate the solvent.

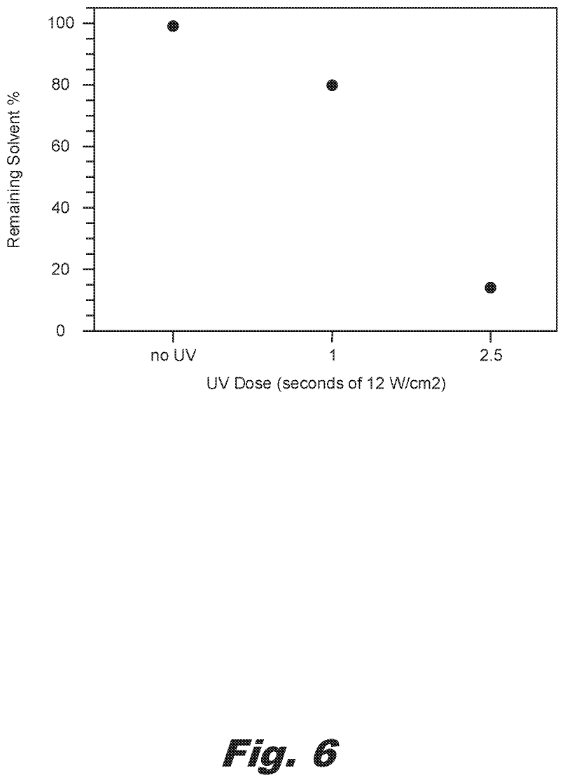

FIG. 6 depicts solvent evaporation based on UV dosage, according to an example of the principles described herein. In FIG. 6, the solvent evaporation is measured as a percent of remaining solvent. As is depicted in FIG. 6, the amount of solvent removed increases as the UV dosage increases.

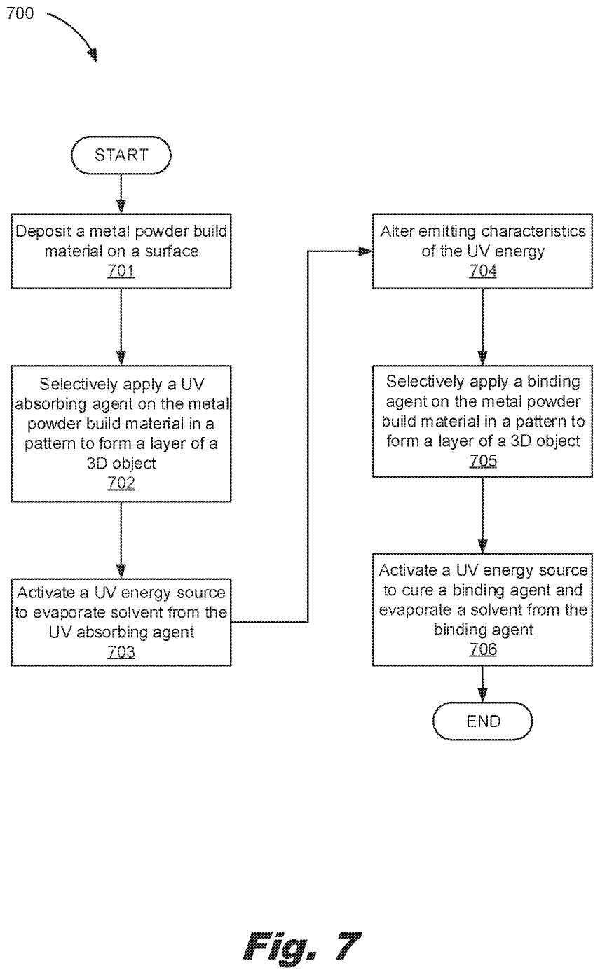

FIG. 7 is a flow chart of a method (700) for layer-by-layer solvent evaporation, according to an example of the principles described herein. In the method (700) depicted in FIG. 7, in addition to using a binding agent (FIG. 5, 526), a UV absorbing agent is used to further increases solvent removal. As with the method (FIG. 4, 400) depicted in FIG. 4, the current method (700) includes deposition (block 701) of a metal powder build material (FIG. 5, 524) on a surface such as a bed (FIG. 2, 210).

With metal powder build material (FIG. 5, 524) spread, the method (700) includes selectively applying (block 702) a UV absorbing agent on a portion of the metal powder build material (FIG. 5, 524) that is to form a layer of a 3D object (FIG. 2, 212). As described above, the UV absorbing agent is applied (block 702) via an agent distribution system (FIG. 1, 104). Specifically, the controller (FIG. 2, 216) may execute instructions to control the agent distribution system (FIG. 1, 104) to deposit the UV absorbing agent onto predetermined portion(s) of the metal powder build material (FIG. 5, 524) that are to become part of a green object and are to ultimately be sintered to form the 3D object. As an example, if the 3D object (FIG. 2, 212) that is to be formed is to be shaped like a cube or cylinder, the UV absorbing agent may be deposited in a square pattern or a circular pattern (from a top view), respectively, on at least a portion of the layer of the metal powder build material (FIG. 5, 524).

According to the method (700), the UV energy source (FIG. 1, 106) is activated (block 703) to evaporate a solvent of the UV absorbing agent, such that a “dry” UV absorbing agent is present. As described above, the UV absorbing agent increases the absorption of UV energy such that more solvent from the binding agent (FIG. 5, 526) is removed, thus increasing geometrical accuracy and mechanical strength of the green, and sintered, 3D object (FIG. 2, 212). In some example, this may include emitting UV waves having a wavelength of between 240-450 nanometers, and as a specific example of 395 nm, for a period of 0.5 to 5 seconds.

In some examples, the method (700) includes altering (block 704) emitting characteristics of the UV energy based on various conditions attendant in the additive manufacturing process. That is, it may be that particular build materials (FIG. 5, 524) or binding agents (FIG. 5, 526) dictate particular UV irradiation so as to 1) effectively remove solvent and/or 2) maintain particular material properties of the 3D object (FIG. 2, 212). For example, a particular binding agent solvent may be more resilient to evaporation such that a higher UV intensity is desired, i.e., longer duration or different frequency. By comparison, it may be that too intense exposure to UV irradiation may compromise a binding component's ability to cure the part, thus resulting in a weakened green part.

As yet another example, there may be regions of the 3D object (FIG. 2, 212) where greater variety in dimensional accuracy and mechanical strength are permissible. For example, at an interior surface of a 3D object (FIG. 2, 212), geometric variance may be acceptable. Accordingly, in this example UV irradiation may be altered to accommodate these different conditions. Altering emitting characteristics may include selecting which of the UV LEDs are active and which are not, a duration of IV irradiation by the UV LEDs, a wavelength of UV irradiation, and a strength of the emission from each UV LED. While particular reference is made to a few specific emitting characteristics that could be altered (block 704), a variety of other characteristics may be altered. Each of which may be altered based on the binding agent (FIG. 5, 526), the metal powder build material (FIG. 5, 524), the pattern, and/or the level of detail of the 3D object (FIG. 2, 212).

With the emitting characteristics set, a binding agent (FIG. 5, 524) may be selectively applied (block 705), and the UV energy source (FIG. 1, 106) activated (block 706) to cure the binding agent and to evaporate a solvent of the binding agent (FIG. 5, 524). These operations may be performed as described above in connection with FIG. 4.

Activating (block 703) the UV energy source (FIG. 1, 106) to evaporate solvents in the UV absorbing agent and activating (block 706) the UV energy source (FIG. 1, 106) to evaporate solvents from the binding agent (FIG. 5, 526) may be to different degrees. For example, to evaporate solvents from the UV absorbing agent, the UV energy source (FIG. 1, 106) may be activated (block 703) such that the bed (FIG. 2, 210) is heated to a temperature of between 40 and 100 degrees Celsius. By comparison, to evaporate solvents from the binding agent (FIG. 5, 526), the UV energy source (FIG. 1, 106) may be activated (block 706) such that the bed (FIG. 2, 210) is heated to a temperature of between 150 and 250 degrees Celsius.

As with the method (400) of FIG. 4, this method (700) may be performed in a layer-by-layer fashion. That is, for each layer, 1) a UV absorbing agent is deposited and solvents evaporated therefrom, 2) a binding agent is deposited and cured, and 3) solvents thereof evaporated. These operations are repeated for each layer of a 3D object (FIG. 2, 212) such that object-level curing and solvent evaporation may be avoided, which object level curing and solvent evaporation may remove less solvent. As less solvent is removed, object-level solvent evaporation is less effective and thus results in 3D objects having a reduced strength as compared to a layer-by-layer solvent evaporation.

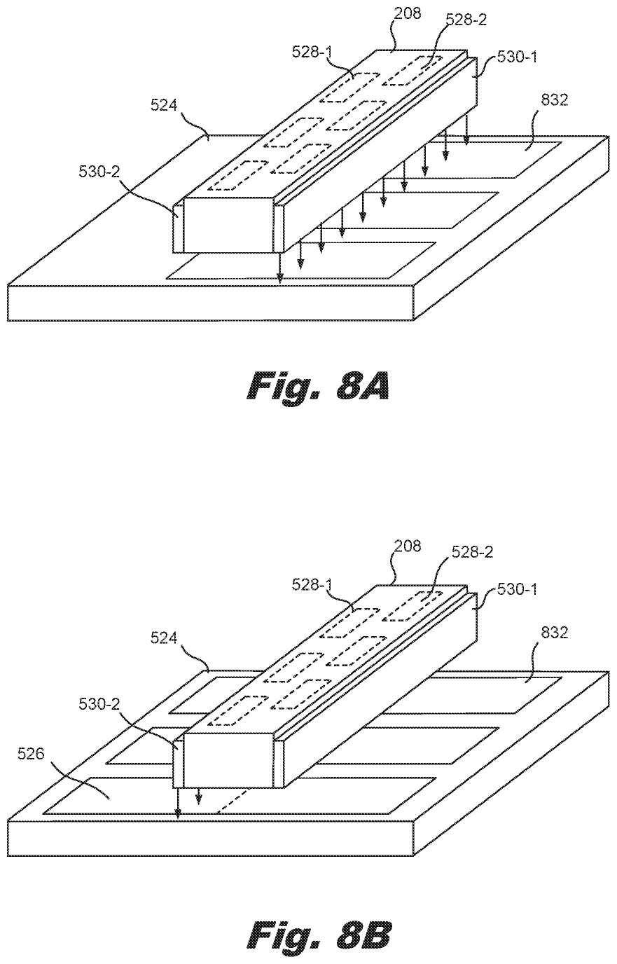

FIGS. 8A and 8B depict the layer-by-layer solvent evaporation via ultraviolet (UV) energy, according to another example of the principles described herein. Specifically, FIGS. 8A and 8B depict an example, where a UV absorbing agent (832) is deposited on the bed (210). In this example, the UV energy source (FIG. 1, 106) may include two UV arrays (530-1, 530-2), a first (530-1) of which is to be active when the UV absorbing agent (832) is selectively deposited and the second UV array (530-2) to be active when a binding agent (526) is selectively deposited. In this particular example, the UV absorbing agent (832) is selectively deposited via a pass of the carriage (208) in a first direction across the surface while the binding agent (526) is applied via a return pass of the carriage (208) in a second direction across the surface.

That is, as depicted in FIG. 8A, a carriage (208) may pass over the surface of the metal powder build material (524). While the carriage (208) is moving, a first set of printheads (528-1) of the agent distribution system (FIG. 1, 104) may be activated to eject a UV absorbing agent (832) on the metal powder build material (524). For simplicity, a single printhead of the first set of printheads (528-1) of the agent distribution system (FIG. 1, 104) is indicated with a reference number.

FIG. 8A also depicts the first UV array (530-1), which in the example depicted in FIG. 8A is an array that is mounted to the carriage (208). As described above, in other examples, the UV energy source (FIG. 1, 106) may be immobile and fixed above the bed (FIG. 2, 210). In either example, the UV energy source (FIG. 1, 106) is active simultaneously with, or shortly after the deposition of the agents. In one particular example, the first UV array (530-1) and the first set of printheads (528-1) may be active during the same pass. That is, on the same pass that the first set of printheads (528-1) deposit the UV absorbing agent (832), the first UV array (530-1) may be activated to evaporate the solvent therein. In these examples, the speed of the carriage (208) may be adjusted to ensure infiltration of the UV absorbing agent (832) before the first UV array (530-1) irradiates the surface.

On a return pass indicated in FIG. 8B, a second set of printheads (528-2) deposit the binding agent (526) and the second UV array (530-2) may be activated to evaporate the solvent therein and to cure the binding agent (526). In these examples, the speed of the carriage (208) may be adjusted to ensure infiltration of the binding agent (526) before the second UV array (530-2) irradiates the surface.

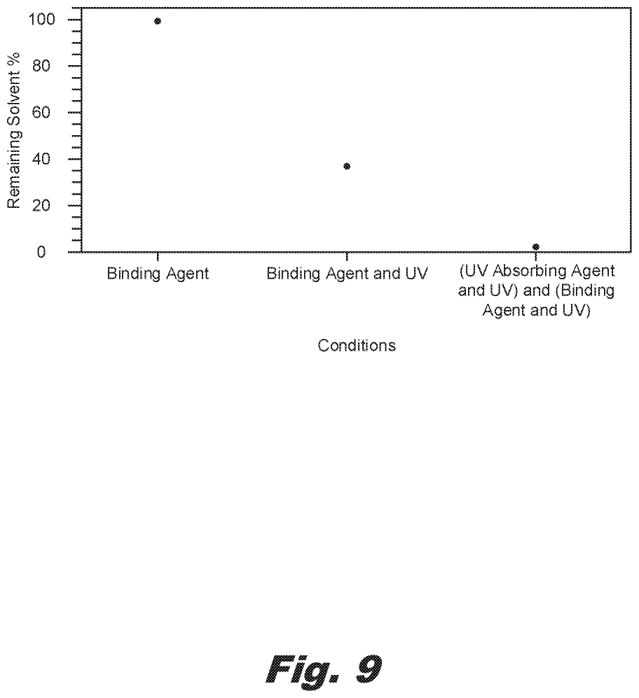

FIG. 9 depicts solvent evaporation using UV energy and a UV absorbing agent (FIG. 8, 832), according to an example of the principles described herein. Specifically, FIG. 9 depicts the quantity of solvent left in a green object (FIG. 2, 212) when just a binding agent (FIG. 5, 526), and no UV absorbing agent (FIG. 8, 832) and UV evaporative treatment is used. As depicted in FIG. 9, when UV evaporative treatment is used, solvent content in the green object (FIG. 2, 212) is reduced to 37% of the original value. Still further, when a UV absorbing agent (FIG. 8, 832) and UV evaporative treatment and a binding agent (FIG. 5, 526) and UV evaporative treatment is used, solvent content in the green object (FIG. 2, 212) is reduced to 2% of the original value. Given the relationship between solvent content, mechanical strength, and dimensional accuracy, FIG. 9 clearly indicates the enhancements to the additive manufacturing operations when a UV evaporate treatment and/or UV absorbing agent (FIG. 8, 832) are used.

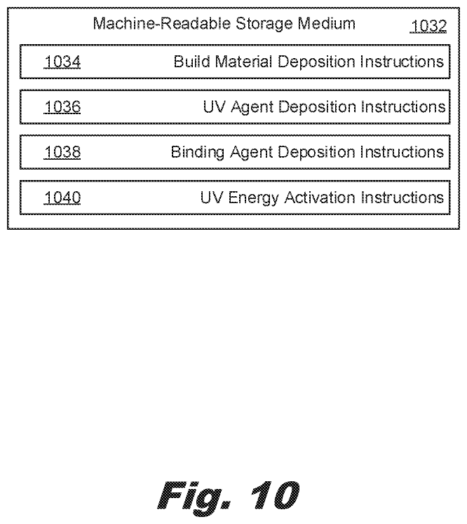

FIG. 10 depicts a non-transitory machine-readable storage medium (1032) for layer-by-layer solvent evaporation, according to an example of the principles described herein. To achieve its desired functionality, a controller (FIG. 2, 216) includes various hardware components. Specifically, a controller (FIG. 2, 216) includes a processor and a machine-readable storage medium (1032). The machine-readable storage medium (1032) is communicatively coupled to the processor. The machine-readable storage medium (1032) includes a number of instructions (1034, 1036, 1038, 1040) for performing a designated function. The machine-readable storage medium (1032) causes the processor to execute the designated function of the instructions (1034, 1036, 1038, 1040). The machine-readable storage medium (1032) can store data, programs, instructions, or any other machine-readable data that can be utilized to operate the additive manufacturing system (FIG. 1, 100). Machine-readable storage medium (1032) can store computer readable instructions that the processor of the controller (FIG. 2, 216) can process, or execute. The machine-readable storage medium (1032) can be an electronic, magnetic, optical, or other physical storage device that contains or stores executable instructions. Machine-readable storage medium (1032) may be, for example, Random Access Memory (RAM), an Electrically Erasable Programmable Read-Only Memory (EEPROM), a storage device, an optical disc, etc. The machine-readable storage medium (1032) may be a non-transitory machine-readable storage medium (1032).

Referring to FIG. 10, build material deposition instructions (1034), when executed by the processor, cause the processor to, per layer of a multi-layer three-dimensional (3D) object to be printed, control deposition of a metal powder build material on a surface. UV agent deposition instructions (1036), when executed by the processor, may cause the processor to control deposition of an ultraviolet absorbing agent in a pattern of a layer of the 3D object to be printed. Binding agent deposition instructions (1038), when executed by the processor, may cause the processor to control deposition of a binding agent in a pattern of a layer of the 3D object to be printed. UV energy activation instructions (1040), when executed by the processor, may cause the processor to 1) selectively activate a UV LED array to a first state to evaporate a solvent of the UV absorbing agent; 2) selectively activate the UV LED array to a second state to cure the binding agent to glue together metal powder build material particles with the binding agent disposed thereon; and 3) selectively activate the UV LED array to a third state to evaporate a solvent of the binding agent.

Such systems and methods 1) remove binding agent solvent from a “green” 3D object; 2) increase dimensional accuracy and strength of “green” 3D objects; 3) provide selective heating of just those portions of the metal powder build material that are to form the 3D object; 4) exhibit high energy conversion and low thermal inertia; and 5) allow for patterning of heating radiation by selectively switching individual LEDs in a UV array. However, it is contemplated that the systems and methods disclosed herein may address other matters and deficiencies in a number of technical areas.

What is claimed is:

1. An additive manufacturing system, comprising:
a build material distributor to deposit metal powder build material;
an agent distribution system to selectively deposit a binding agent on the metal powder build material in a pattern of a layer of a three-dimensional (3D) object to be printed; and
an ultraviolet (UV) energy source to, in a layer-by-layer fashion:
cure the binding agent to join together metal powder build material with binding agent disposed thereon; and
evaporate a solvent of the binding agent.

2. The additive manufacturing system of claim 1, wherein the UV energy source is an array of UV light-emitting diodes (LEDs).

3. The additive manufacturing system of claim 2, further comprising a controller to individually control each of the UV LEDs.

4. The additive manufacturing system of claim 1, wherein the agent distribution system is to selectively deposit a UV absorbing agent on the metal powder build material in the pattern.

5. The additive manufacturing system of claim 4, wherein the agent distribution system separately distributes the binding agent and the UV absorbing agent.

6. The additive manufacturing system of claim 4, wherein the binding agent and the UV absorbing agent are mixed as a single compound.

7. The additive manufacturing system of claim 1, wherein the UV energy source is disposed on a carriage along with the agent distribution system, which carriage moves across the metal powder build material.

8. The additive manufacturing system of claim 7, wherein:
the UV absorbing agent is selectively applied via a pass of a carriage in a first direction across the metal powder build material; and
the binding agent is applied via a return pass of the carriage in a second direction across the metal powder build material.

9. The additive manufacturing system of claim 1, wherein:
the UV energy source comprises two UV arrays;
a first UV array which is to be activate when the binding agent is selectively deposited; and
a second UV array which is to be active when a UV absorbing agent is selectively deposited.

10. The additive manufacturing system of claim 1, wherein the UV energy source emits energy having a wavelength of between 240 and 450 nanometers.

11. A method, comprising:
in a layer-by-layer fashion:
depositing a metal powder build material;
selectively applying a binding agent on a portion of the metal powder build material that is to form a layer of a three-dimensional (3D) object; and
activating an ultraviolet (UV) energy source to:
cure the binding agent to join together metal powder build material particles with the binding agent disposed thereon; and
evaporate a solvent of the binding agent.

12. The method of claim 11, further comprising:
selectively applying a UV absorbing agent on a portion of the metal powder build material that is to form the layer of the 3D object; and
activating the UV energy source to evaporate a solvent of the UV absorbing agent.

13. The method of claim 11, further comprising altering emitting characteristics of the UV energy based on a component selected from the group consisting of:
the binding agent;
the metal powder build material; and
a level of detail of the 3D object.

14. A non-transitory machine-readable storage medium encoded with instructions executable by a processor, the machine-readable storage medium comprising instructions to:
per layer of a multi-layer three-dimensional (3D) object to be printed:
control deposition of a metal powder build material;
control deposition of an ultraviolet (UV) absorbing agent in a pattern of a layer of the 3D object to be printed;
selectively activate a UV light-emitting diode (LED) array to evaporate a solvent of the UV absorbing agent;
control deposition of a binding agent in a pattern of a layer of the 3D object to be printed;
selectively activate the UV LED array to:
cure the binding agent to join together metal powder build material particles with the binding agent disposed thereon; and
evaporate a solvent of the binding agent.

15. The non-transitory machine-readable storage medium of claim 14, wherein:
selectively activating the UV LED array to evaporate the solvent of the UV absorbing agent comprises activating the UV LED array to heat the surface to a temperature of between 40 degrees Celsius and 100 degrees Celsius; and
selectively activating the UV LED array to evaporate the solvent of the binding agent comprises activating the UV LED array to heat the surface to a temperature of between 50 degrees Celsius and 150 degrees Celsius.
